(19) United States
(12) Patent Application Publication
(10) Pub. No.: US 2013/0317993 A1
(43) Pub. Date: Nov. 28, 2013

(54) METHOD AND APPARATUS FOR LINKING USER SESSIONS AND ESTABLISHING IDENTITY ACROSS CHANNELS

(71) Applicant: 24/7 CUSTOMER, INC., Campbell, CA (US)

(72) Inventors: Eric WASSERMAN, Berkeley, CA (US); Patrick NGUYEN, Alameda, CA (US); Andrew CHANG, Palo Alto, CA (US)

(73) Assignee: 24/7 CUSTOMER, INC., Campbell, CA (US)

(21) Appl. No.: 13/763,456

(22) Filed: Feb. 8, 2013

Related U.S. Application Data
(60) Provisional application No. 61/652,022, filed on May 25, 2012.

(51) Int. Cl. G06Q 30/00

(52) U.S. Cl. CPC G06Q 30/016
USPC 705/304

(57) ABSTRACT

A customer support system exchanges customer data, such as the customer's identity, activity, etc. across multiple channels to enable better customer service. A further embodiment of the invention collects user interaction data from non-CCS channels, such as Facebook® posts, and predicts the intent of customer to provide services to the customer accordingly.

### CROSS REFERENCE TO RELATED APPLICATIONS

This application claims priority to U.S. provisional patent application Ser. No. 61/652,022, filed May 25, 2012, which application is incorporated herein in its entirety by this reference thereto.

### BACKGROUND OF THE INVENTION

1. Technical Field

The invention relates to customer care support systems. More particularly, the invention relates to intelligent, adaptive customer care support systems that optimize interactions to enhance the customer's experience.

2. Description of the Background Art

Today, in an age of automated business systems, intelligent customer care support systems play a major role in serving customers. Customers or users expect an optimal experience from customer care support (CCS) systems of those enterprises with which they interact. Giving user-friendly, informative, time-efficient customer support is a necessity for every enterprise.

Customers interact with CCS systems of an enterprise across a multitude of channels. These channels include interactions with interactive voice response systems (IVR), Web, mobile applications, social networks, etc., as well as with human voice agents, chat agents, etc.

In many channels, the identity of the customer may not be known or may only be known in some of the channels. Existing technology uses data within one channel to correlate multiple sessions in the same channel, but cannot correlate sessions from multiple channels. For example, an automatic number identification (ANI) system can be used to link a series of telephone calls made by a single caller. Similarly, a Web cookie can be used to link multiple Web sessions.

It would be advantageous to provide a method and apparatus that overcomes known problems encountered with existing technology, and that provides a better-equipped, more efficient customer care support system.

### SUMMARY OF THE INVENTION

Embodiments of the invention provide a method and apparatus that overcomes known problems encountered with existing technology, and provide a better-equipped, more efficient customer care support system. In an embodiment, a customer support system exchanges customer data, such as the customer's identity, activity, etc. across multiple channels to enable better customer service. A further embodiment of the invention collects customer interaction data from non-CCS channels, such as Facebook® posts, and predicts the intent of customer to provide services to the customer accordingly.

### BRIEF DESCRIPTION OF THE DRAWINGS

FIG. 1 is a block schematic diagram that depicts a customer care support system the includes multichannel communication network according to the invention;

FIG. 2 is a block schematic diagram that depicts a method and apparatus that identifies the presence of a customer across multiple channels and that links the customer's sessions across the multiple channels by integrating multichannel data according to the invention;

FIG. 3 is a block schematic diagram that shows the customer care support systems according to the invention;

FIG. 4 is a screen shot showing verbal communication in an IVR augmented with pertinent graphical images that are presented to the customer through a Web browser in a coincident Web session; and

FIG. 5 is a block schematic diagram that depicts a machine in the exemplary form of a computer system within which a set of instructions for causing the machine to perform any of the herein disclosed methodologies may be executed.

### DETAILED DESCRIPTION OF THE INVENTION

Embodiments of the invention provide a method and apparatus that overcomes known problems encountered with existing technology, and provide a better-equipped, more efficient customer care support system. In an embodiment, a customer support system exchanges customer data, such as the customer's identity, activity, etc. across multiple channels to enable better customer service. A further embodiment of the invention collects customer interaction data from non-CCS channels, such as Facebook® posts, and predicts the intent of customer to provide services to the customer accordingly.

There are multiple types of identification. In technologies prior to this invention, there is the notion of a channel identifier that allows activity data from multiple sessions to be associated. The channel identifier is typically not directly linked to any personally identifying information (PII). The channel identifier can be said to serve as a proxy for the PII that is conventionally thought to identify an individual person. Sometimes activity within a channel includes the introduction of PII. For example, when a Web user inputs his name and address in a Web form this introduces the PII into the Web channel. The unique Web cookie in that user's browser, which is the Web channel identifier, can thereby be linked with that PII. Thus, the PII-based identity of the person browsing becomes known for all the sessions that share the channel identifier, i.e. the Web cookie, prior to, and subsequent to, the session in which the PII was supplied.

An embodiment of the invention expands a PII by including processes for connecting user interaction data in multiple sessions and multiple channels through:

(1) Ties between channel identifiers, e.g. tying a Web cookie to an ANI;

(2) Ties between a channel identifier and a PII;

(3) Ties between a non-PII property that appears in multiple channels, e.g. the same order number is input in a Web form and an IVR; and

(4) Ties between a non-PII property that appears in a channel and a PII in an external system, e.g. an order number appearing in a Web session that is associated with a PII, such as name and address in an order processing system.

In doing so, an embodiment of the invention broadens the scope of the interaction data that can be attributed to a single person by using any combination of the three ties; and it broadens the scope of the interaction data that can be personally identified insofar as there a tie between a channel identifier and a PII in any of the interaction data.

The channel identifiers can transcend the enterprises for which the customer service is being provided. This allows for customer service to be based on customer interaction data across enterprises. For example, an airline customer could use an IVR to postpone a trip. When he calls the rental car company from the same phone the ANI can be used to identify this as the same person who just changed his trip plans, and the system can proactively offer to make a corresponding adjustment to the rental car reservation. To the extent that the channel identifiers have ties between them, the customer could have used two different channels for this scenario, e.g. using the Web to change the airline reservation and using IVR for the rental car, where information gathered in the first interaction (web/airline) is used in handling the second interaction (IVR/rental car).

In one embodiment, customer identification information comes from various sources in addition to information normally received via the CCS's channels. Examples of such various sources include an activity carried out by the customer with a point of sale system or delivery system, where the order or payment system is correlated by time, place, and/or content with a customer communication in a channel. In one embodiment, once a customer has been identified in any of the participating channels, a tying event is used to transfer this identity information to other channels in which the customer was heretofore unidentified. This enables the CCS to serve the customer better, based on the interactions that customer has had in such other channels or preferences that user has selected in such other channels.

In one embodiment, the system proactively collects various data related to customer interaction in non-CCS channels, such as Facebook® posts, Google® searches, etc., and then analyzes such data using textual semantic analysis techniques, such as Latent Semantic Indexing and/or general machine learning techniques for classification and segmentation, such as Naïve Bayes Classifier, Support Vector Machines, and Artificial Neural Networks to understand customer requirements or customer nature. This analysis helps the CCS to serve the customer better when the customer interacts with the CCS, or to offer proactively products or services to the customer for which the customer is looking.

In another embodiment, once a tie between channels is established the presence of the customer in a number of channels can be established, thus allowing for communication via one channel to be augmented or transferred to another channel that may be more optimal. The alternative channel may contain a different mode. For example, verbal communication in an IVR can be augmented with pertinent graphical images presented through a Web browser in a coincident Web session.

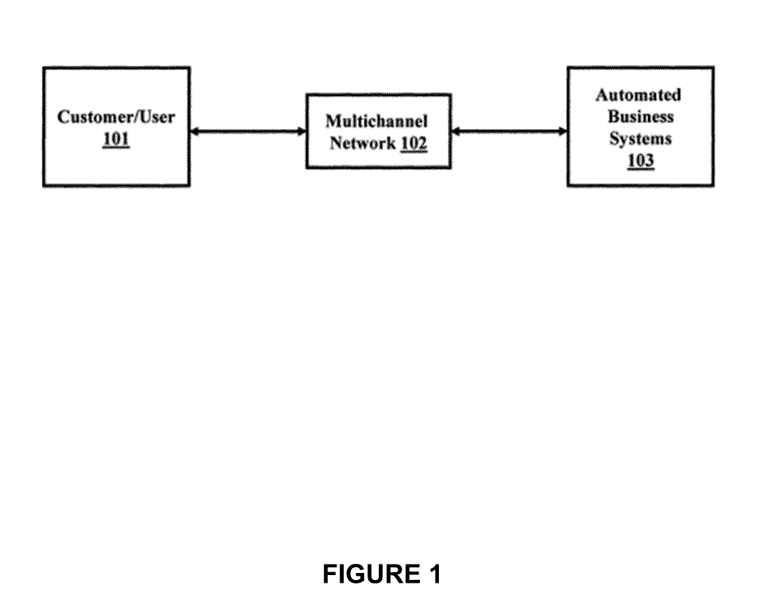

FIG. 1 is a block schematic diagram that depicts a system for customer care support that includes a multichannel communication network. The system depicted comprises a customer interface 101 and an automated business system 103 that are interconnected via a multichannel communication network 102. The customer can be any person who is communicating over the available multichannel network 102 via, for example, social networks, discussion forums, emails, SMS, voice calls, etc. The automated business system comprises a customer care support system that includes, for example, interactive voice response (IVR), live agents, chat agents, etc. that are supported by a control and processing module, a data integration module, a data analysis module, etc.

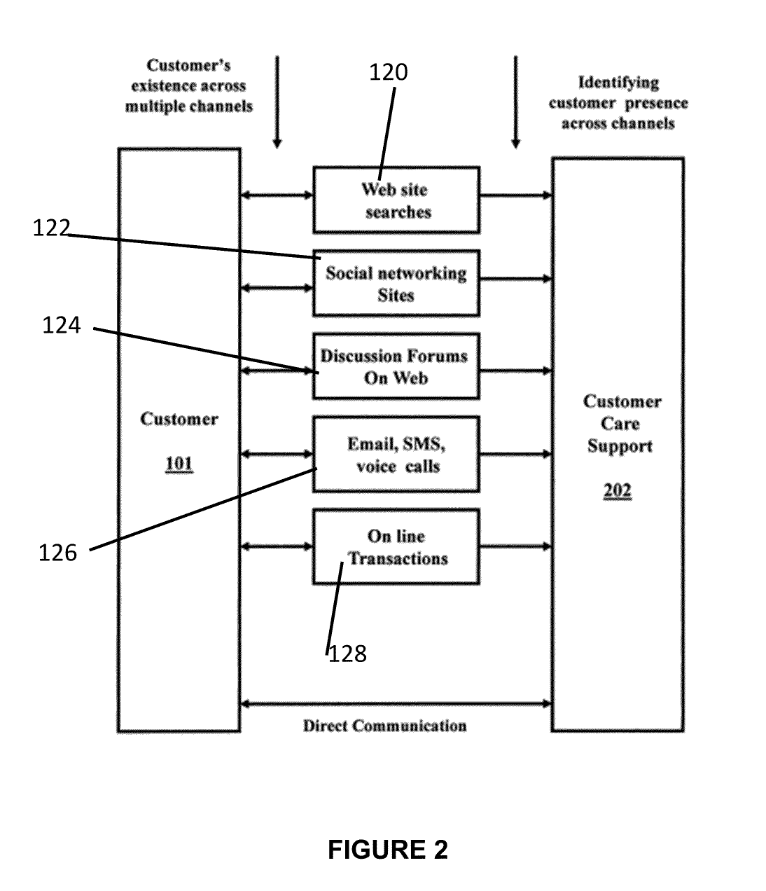

FIG. 2 is a block schematic diagram that depicts a system according to the invention which comprises the customer interface 101 and an automated business system 103 that includes a customer care support (CCS) system 202, each of which is connected through the multichannel communication network 102. In operation, customers use multiple channels to interact with the CCS. In an embodiment, the channels include, for example, Web sites 120, emails and SMS 126, discussion forums on the Internet 124, social networks 122, mobile applications, IVR, live agents, etc. The CCS system 202 keeps track of communications that have transpired over multiple channels by identifying the customer across such multiple channels. The CCS gathers customer data from all possible sources, such as Facebook® posts, Google® searches, online purchasing 128, etc., correlates such data by tying events, and keeps a record in a database along with customer profile information. Thus, in an embodiment, there is a class of interaction events that are referred to as tie events. These tie events tie interaction event data in two channels together. The interaction data from each channel are stored in a database as a series of events recording what happened. For example, at time t=1 the Web page with URL http://xyz loaded, at time t=2 the user clicked button labeled “UVW”, etc. As part of the series of events there are tying events that include an identifier for sessions in the current channel, e.g. the Web session identifier, and another channel, e.g. the customer phone number for a phone call. Similarly, the interaction data in the phone call, e.g. to an IVR, is logged. The tying events are used to provide a cross-reference so that interaction events logged in one channel using its natural identifier, e.g. the Web channel http cookie, can be associated with interaction events logged for activity in another channel with its identifier, e.g. the IVR channel caller's phone number. The tie event is a single event written to either or both channels that identifies the other channel's identifier, e.g. a Web interaction event that includes the Web visitor's phone number).

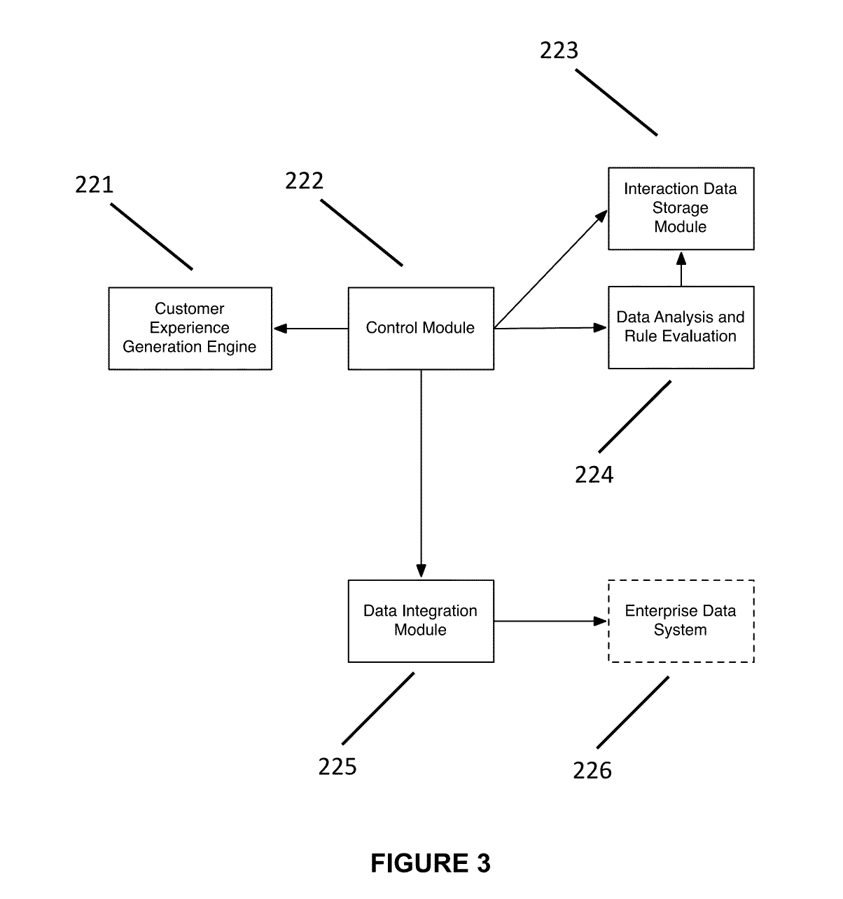

The customer care support system includes, for example, interactive voice response (IVR), Web-based interactive pages/forms, and support systems for live voice and chat agents. FIG. 3 is a block schematic diagram that shows the customer care support systems which, generally, comprise a module for customer experience generation 221, e.g. Web pages, audio prompts and grammars; a control module 222 for coordinating interactions across multiple channels, as well as with backend enterprise data systems; a module for collecting and storing customer interaction event data 223; and a component 224 for analyzing interaction data collected over time and using such data to build machine learning and other analytical models that are used for evaluating rules that determine how to handle current customer interactions based on this past data. A data integration module 225 provides an interface between the control module and external enterprise data systems 226. Examples of the enterprise data systems include customer relationship management databases and order processing systems, etc., although those skilled in the art will appreciate that other systems may be used in connection with the invention.

Whenever the customer interacts with the CCS, the system associates data from many CCS channels and non-CCS channels using the index built from the tie events. In an embodiment, a data integration and analysis module uses all previous tied events to predict the intent of the identified customer for this current communication, and simultaneously checks with all other CCS channels to determine if the same customer is interacting with any of the several channels concurrently. In an embodiment, the system maintains an index built from the tie events in each channel. An example of an entry in the index is a particular HTTP cookie that is tied to a particular phone number (ANI). When the customer interacts in any channel, the channel's identifier is used to look up all other activity in other channels using this index. If the customer is concurrently interacting in two different channels, the event streams from the two channels reflect this, including events in sessions that overlap in time.

If the same customer is interacting with any of the several channels concurrently the system collects information about that interaction. Based on the collected information, the CCS offers the customer services in the current channel that are related to the interaction between customer and the other channel. In an embodiment, interaction data in one channel are used to inform the handling of the customer in another channel. For example, if a customer has previously engaged in activity that ties Web channels to phone channels and the customer has browsed at a retail Website for 35 mm cameras, then when the same customer calls the camera retailer's IVR system, the IVR can use the previous browsing history information to adjust its product upsell message to offer deals on 35 mm cameras or accessories.

If the CCS finds that the customer can be better served by using other channels than that with which the customer is concurrently interacting, then CCS offers integrated services to the customer by using both the current channel and the other channels, or it diverts the customer to the other channel from the channel with which customer is concurrently interacting. If the customer is interacting on two channels at once, the CCS can use the multi-channel data to coordinate the experience across the two channels. For example, if the camera shopper still has a Web page open when he makes the call to the IVR, the IVR can offer a deal on a particular camera model and simultaneously push the Web browser to the Web page for that product. This is possible because the IVR phone call is from a phone number that is associated with the HTTP cookie for that Web browser. The customer's Web session, also produced by the CCS, can be identified and altered to coordinate with the IVR interaction.

In one embodiment, the customer interacts with one channel of the CCS, for example with an online chat support channel. At a later point in time, the same customer interacts with another channel of the CCS system, for example over the IVR channel. In this example the serving channel, i.e. IVR, assembles all data related to the customer across all channels, including the online chat support channel, understands the customer's requirements based on the data collected from all other channels, and offers services accordingly, thereby improving the customer's service experience.

In another embodiment, pay card usage data can be used as another feed to tie sessions together. Payment card usage in a channel can be correlated with accounting information and/or location, time, and/or product. If the same payment card is used in two different channels, e.g. for a purchase on the Web and another separate purchase in an IVR, then both the HTTP cookie and customer phone number (ANI) are associated through a tie event with the credit card number. Therefore, they are transitively associated with one another, i.e. the HTTP cookie and all the activity in the Web can be correlated with all the IVR activity in calls from the phone number. Logging the usage of the payment card for the purposes of user identification is a particular form of tie event.

In another embodiment, intelligent agent type services are provided to customers. Here, the system infers goals and interests of the user in seeking out opportunities and information, and coordinates the services across multiple enterprises with whom the customer does business. The channel identifiers transcend enterprise boundaries. If the same Web browser is used on multiple enterprise Websites that log their interaction data to the same CCS data store, then the interactions for different enterprises can be coordinated. For example, a if customer books a first-class seat to New York on an airline Website and then goes to a hotel Website also served by a CCS that shares the airline's interaction data, the hotel Website can tailor its experience to the upscale, e.g. because the ticket was first-class, New York visitor, e.g. because the ticket was to New York. The same is true if the customer calls the hotel's IVR instead if any of the customer's Web and phone interactions have ever included an event that ties them.

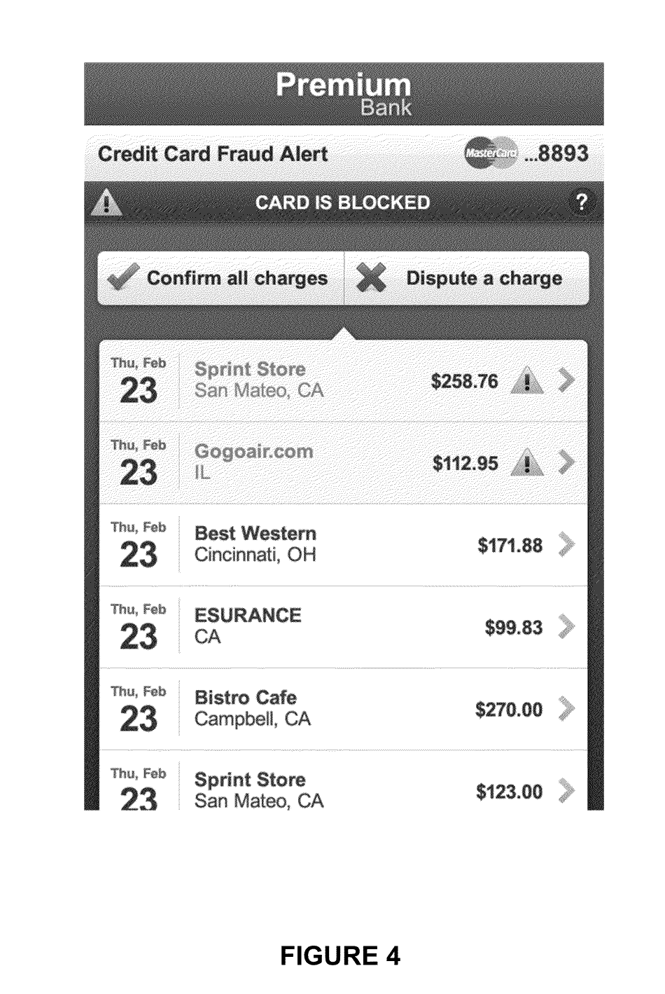

In another embodiment, verbal communication in an IVR can be augmented with pertinent graphical images that are presented to the customer through a Web browser in a coincident Web session (see FIG. 4). To create the Web session, in such case, the IVR system sends an SMS to the caller's phone number. The SMS contains a URL linking to a Web page. The URL also contains a unique identifier produced by the IVR with which the caller clicking on URL in the SMS is provided access to the Web page. The loading of the Web page produces a tying event that connects the Web channel to the phone (IVR) channel for that user. Further interactions in the two channels are thereby coordinated. In this way, more information can be brought to bear in predicting the customer's intent by tying the IVR and Web channels together, thereby allowing the IVR to provide a better call experience to the customer.

In another embodiment, if the customer has been identified in any of the participating channels, a tying event is used to transfer this identity to other channels in which customer was heretofore unidentified. If the customer identifies himself in a channel using his real name or another form of personally identifying information (PII), and there exist tie events from that channel to another channel, then the identity of the person in the latter channel can be inferred from the PII in the former.

Many tying events can be included to collect relevant customer data. Such tying events include, for example:
A “me” contact in a mobile phone or tablet, for example where the “me” contact in a mobile phone or tablet can be used to create a tie between a channel identifier and a PII that ties the mobile device's channel identifier, e.g. its hardware device ID or MAC address, with the PII in the contact, e.g. name and address.
A PayPal® or equivalent purchase for a particular product at a time and location, for example, in a mobile device session, i.e. a mobile channel, if the user browses for information about a product and then, using a separate channel, e.g. a voice call, purchases the product, then the particular product, price, and time of purchase constitute a tie between a non-PII property that appears in multiple channels; that is, a between the first channel, i.e. the mobile channel with a device hardware ID for the channel ID and second channel, i.e. the phone channel with the channel ID comprising the phone number.
An SMS with an included Web link (URL) that contains a unique identifying parameter sent to the ANI of the caller, for example where clicking on the URL in the customer's Web browser, and thereby setting a Web cookie, produces interaction data including both the channel identifier, i.e. the Web cookie, and the identifying parameter in the URL. This unique URL parameter thus constitutes the non-PII data in a tie between a non-PII property that appears in multiple channels: that is, between the phone channel with its channel identifier, i.e. the ANI, and the Web channel with its channel identifier, i.e. Web cookie.
An email with an included Web link (URL) that contains a unique identifying parameter. Clicking on the link ties the Web session identifier to the originating session, e.g. a voice agent call, where the email address was provided by caller. This is a tie between a non-PII property that appears in multiple channels; that is, between the email channel, with the channel identifier comprising the email address, and the Web channel, with the channel identifier comprising the Web cookie, where the non-PII shared property is the URL parameter.
A link in a Web page with a phone number from a rotating pool of phone numbers, where correlation in time establishes which Web visitor is correlated with the phone call's ANI. For an Internet-enabled phone, the same device may be used in both cases. By calling the phone number the CCS system ties the ANI of the individual with the Web cookie of the browser showing the phone number. This is a tie between a non-PII property that appears in multiple channels; that is, where the non-PII shared property is the dialed phone number plus the time of the call.
A Web page that asks the customer to tie to an ongoing phone session by entering a phone number. This is a tie between channel identifiers, where the Web channel identifier is a Web cookie and the phone channel identifier is the phone number.
A Web page that asks the customer for the customer's phone number to have an outgoing call to their phone initiated by the enterprise, e.g. where the customer gives the phone number for callback to the Web page, thus creating a tie between channel identifiers, where the Web channel identifier is the Web cookie and the phone channel identifier is the phone number.
A Web link (URL) in an SMS with a landing Web page that asks the customer to tie an ongoing phone session to the Web session by entering a phone number, e.g. where the customer gives the phone number in the Web page, thus creating a tie between channel identifiers, e.g. between the Web channel where the identifier is the Web cookie and phone channel where the identifier is the phone number.
A link (URL) to supplemental content with a unique identifying parameter encoded in social media, an email, an SMS, or an instant message. This is tie between a non-PII property that appears in multiple channels, e.g. between the Web where the link is clicked and the channel where the URL appears, for example, a social media channel channel identifier is the user ID; an email channel channel identifier is the email address; a phone channel (sms) channel identifier is the phone number; and an instant message channel channel identifier is the IM handle, with the non-PII property being the unique URL parameter.
A unique purchase identifier, reservation identifier, issue identifier, confirmation number, or order number provided by the customer to different channels, e.g. when checking order status. Here the channels are not specified because they could be any two channels in which the specified non-PII property appears. These are ties between channel identifiers via a non-PII property that appears in those channels.
Checking or scanning a product code in store on a mobile device or kiosk with time and location correlated with purchase of the item, using a third party payment system, such as Square, Google Wallet, near field, etc. This is a tie between a non-PII property that appears in a channel and a PII in an external system, i.e. where the non-PII property is the time/location/product purchase information and one of the channels is a mobile device or kiosk. In this example, the PII associated with the property comes from the payment system.
Asking for entry of a rendezvous code presented in one channel and entered by the customer in another channel. This is a tie between a non-PII property that appears in multiple channels, where the non-PII property is the rendezvous code.
Ordering a reservation or service localized in time, and/or place, and/or for a specific product in one channel, e.g. mobile, and correlating that with identified purchase activity, e.g. order a cab, dinner reservation, to-go pizza order with unique toppings. This is a tie between a non-PII property that appears in a channel and a PII in an external system, where the non-PII property is the combination of time/place/specific product and the PII comes from the payment processing system for the transaction at that time/place/ for that specific product.
Otherwise independent events on different channels or Web sites, correlated by time and location, or time and IP address, even when Network Address Translated (NAT). This is a broad case of ties between a non-PII property that appears in multiple channels, where specific activity in two separate channels, but at the same time and from the same location or IP address, with the time/location providing the non-PII property. For example, where both a desktop Web browser session and a mobile application are used in concert to browse a particular product in close proximity in time from the same NAT'ed IP. The two channels, i.e. the desktop Web with its Web cookie channel identifier and the mobile device with its hardware device ID channel identifier, are tied via the coincident activity.

Computer Implementation

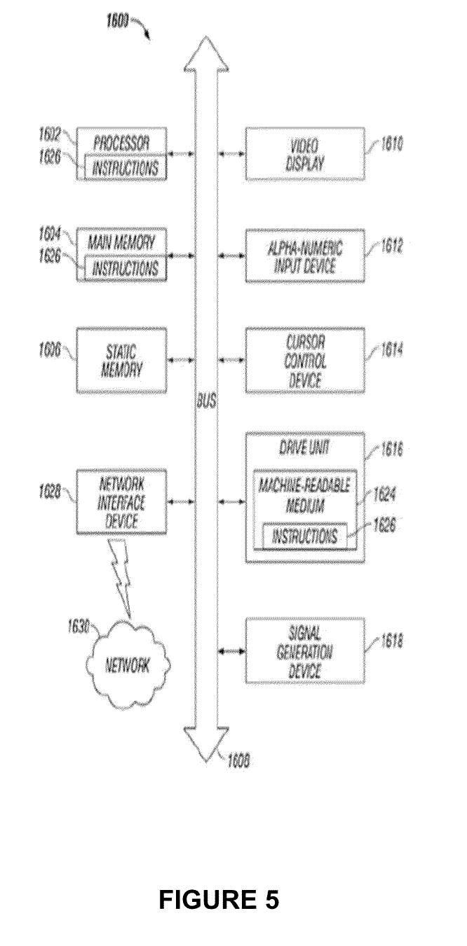

FIG. 5 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method, comprising:
a processor executing instructions for exchanging customer data via a customer support system across a plurality of channels;
said processor executing instructions for receiving said customer data from said plurality of channels, wherein at least one of said channels comprises a customer care support (CCS) channel and at least one of said channels comprises a non-CCS channel; and
said processor executing instructions for applying said customer data in one or more channels based upon any of customer interaction in one or more other channels and preferences that said customer has selected in said one or more other channels.

2. The method of claim 1, further comprising:
said processor executing instructions for collecting customer interaction data from said non-CCS channel and for predicting customer intent therefrom.

3. The method of claim 1, wherein said customer data comprises any of customer identity and customer activity.

4. The method of claim 1, wherein said non-CCS channel conveys customer information that comprises any of an activity carried out by said customer with a point of sale system or delivery system;
said processor executing instructions for correlating said customer information conveyed from said point of sale system or delivery system by said non-CCS channel by any of time, place, and content with said customer communication in said non-CCS channel.

5. The method of claim 1, further comprising:
said processor executing instructions for identifying said customer in one of said channels; and
said processor executing instructions for using a tying event to transfer customer identity information to one or more other channels in which said customer was heretofore unidentified.

6. The method of claim 1, further comprising:
said processor executing instructions for collecting data related to said customer interaction in non-CCS channels; and
said processor executing instructions for analyzing said collected data to understand any of customer requirements and customer nature.

7. The method of claim 1, further comprising:
said processor executing instructions for establishing a tie between one or more of said channels;
said processor executing instructions for establishing customer presence in a plurality of channels; and
responsive thereto, said processor executing instructions for allowing customer communication via one channel to be augmented or transferred to another channel that may be more optimal.

8. The method of claim 1, wherein at least one channel provides a different modes of operation from said other channels.

9. The method of claim 8, wherein verbal communication in an IVR channel are augmented with pertinent graphical images presented through a Web browser in a coincident Web session channel.

10. An apparatus, comprising:
a customer care support (CCS) system, interconnected with a customer interface for receiving customer data, via a multichannel communication network for exchanging said customer data via said CCS across a plurality of channels, said CCS receiving said customer data from said plurality of channels, wherein at least one of said channels comprises a CCS channel and at least one of said channels comprises a non-CCS channel, said CCS applying said customer data in one or more channels based upon any of customer interaction in one or more other channels and preferences that said customer has selected in said one or more other channels.

11. The apparatus of claim 10, said non-CCS channel comprising any of a multichannel network social network, discussion forum, email system, SMS system, and voice call system.

12. The apparatus of claim 10, said CCS further comprising any of:
an intelligent voice response (IVR) system, live agents, and chat agents.

13. The apparatus of claim 10, wherein said customers use a plurality of channels to interact with said CCS; and
wherein said plurality of channels comprise any of Web sites, email, SMS, discussion forums on the Internet, social networks, mobile applications, IVR, and live agents.

14. The apparatus of claim 10, further comprising:
said CCS configured for keeping track of communications that have transpired over a plurality of channels by identifying a customer across said plurality of channels.

15. The apparatus of claim 10, further comprising:
said CCS configured for gathering customer data from a plurality of sources;
said CCS configured for correlating said customer data by analyzing tying events with said customer; and
said CCS configured for storing a record of said customer data and tying events in a database along with customer profile information.

16. The apparatus of claim 10, further comprising:
said CCS configured for identifying said customer by using customer data that is collected from a plurality of CCS channels and non-CCS channels whenever said customer interacts with said CCS.

17. The apparatus of claim 15, further comprising:
a data integration and analysis module for using said tying events to predict the intent of an identified customer for a current communication; and
said data integration and analysis module simultaneously checking with all other CCS channels to determine if the same customer is interacting with any of said other CCS channels concurrently and, if so, collecting information about said interaction.

18. The apparatus of claim 17, based on said collected information, said CCS configured for offering services to said customer in a current channel that are related to the interaction between said customer and said other channel.

19. The apparatus of claim 18, further comprising;
said CCS configured for determining if said customer can be better served by using another channel than that with which said customer is concurrently interacting and, if so, said CCS configured for offering integrated services to said customer by any of using both of said current channel and said other channel and diverting said customer from the channel with which said customer is concurrently interacting to said other channel.

20. The apparatus of claim 10, further comprising:
said CCS configured for collecting customer information from a customer's interaction with Website of an enterprise, which is not part of a CCS channel;
said CCS configured for correlating the identity of said customer with identity information of customers that was previously obtained by said CCS across multiple CCS channels and non-CCS channels;
wherein if a match occurs, then said CCS configured for storing said collected customer information against customer information previously stored in a database.

21. The apparatus of claim 20, further comprising:
said CCS configured for identifying said customer when said customer interacts with said CCS;
said CCS configured for retrieving customer information that is stored against customer information previously stored in said database; and
said CCS configured for proactively offers products or services to said customer that are related to said customer activity over non-CCS channels.

22. The apparatus of claim 10, further comprising:
said CCS configured for using one channel for collecting all data related to said customer across all channels when said customer interacts with one channel of said CCS and, at a later point in time, the same customer interacts with another channel of said CCS;
said CCS configured for determining said customer's requirements on said one channel based on said data collected from all other channels; and
said CCS configured for offering services or products to said customer accordingly.

23. The apparatus of claim 10, further comprising:
said CCS configured for using pay card usage data as a feed to tie sessions together; and
said CCS configured for correlating said pay card usage in a channel with any of accounting information, location, time, and product.

24. The apparatus of claim 10, further comprising:
said CCS configured for providing intelligent agent services to customers by inferring goals and interests of a customer in seeking out opportunities and information; and
said CCS configured for coordinating said intelligent agent services across multiple enterprises that said customer consumes.

25. The apparatus of claim 10, further comprising:
said CCS configured for augmenting verbal communication in an IVR with pertinent graphical images that are presented to said customer through a Web browser in a coincident Web session..

26. The apparatus of claim 10, further comprising:
said CCS configured for using a tying event to transfer customer identity to other channels in which customer was heretofore unidentified if the customer has been identified in any of the participating channels.

27. The apparatus of claim 26, wherein said tying events comprise any of:
“me” contact in a mobile phone or tablet;
PayPal® or equivalent purchase for a particular product at a time and location;
SMS with an included Web link (URL) that contains a unique identifying parameter sent to the ANI of a caller;
email with an included Web link (URL) that contains a unique identifying parameter;
a Web page that asks a customer for the customer's phone number to have an outgoing call to their phone initiated by an enterprise;
a Web link (URL) in an SMS with a landing Web page that asks a customer to tie an ongoing phone session to the Web session by entering a phone number;
a link (URL) to supplemental content with an identifying parameter (person id) encoded in social media, an email, an SMS, or an instant message;
a unique purchase identifier, reservation identifier, issue identifier, confirmation number, or order number provided by a customer to different channels;
checking or scanning a product code in store on a mobile device or kiosk with time and location correlated with purchase of the item, using a third party payment system;
asking for entry of a rendezvous code presented in one channel and entered by a customer in another channel;
ordering a reservation or service localized in time, and/or place, and/or for a specific product in one channel and correlating that with identified purchase activity; and
otherwise independent events on different channels or Web sites, correlated by time and location, or time and IP address.

28. A computer implemented method, comprising:
a processor receiving customer data via a multichannel communication network;
said processor receiving said customer data from said plurality of channels;
said processor applying said customer data in one or more channels based upon customer interaction in one or more other channels and personally identifying information (PII) in said one or more other channels by employing one or more ties between said one or more channels and said one or more other channels, said ties comprising any of:
ties between channel identifiers;
ties between a channel identifier and a PII;
ties between a non-PII property that appears in multiple channels; and
ties between a non-PII property that appears in a channel and a PII in an external system.
